(19) United States
(12) Patent Application Publication
(10) Pub. No.: US 2006/0123210 A1
(43) Pub. Date: Jun. 8, 2006

(54) Method for logically consistent backup of open computer files

(75) Inventors: Gary Pritchett, Rancho Santa Fe, CA (US); David C. Burdette, San Diego, CA (US); Christopher J. Neill, San Diego, CA (US); Anatol Piotrowski, San Diego, CA (US); Reza Razavipour, San Diego, CA (US); Terence Ping Wong, San Diego, CA (US)

Correspondence Address: DUANE MORRIS, LLP;IP DEPARTMENT, 30 SOUTH 17TH STREET, PHILADELPHIA, PA, 19103-4196, US

(73) Assignee: St. Bernard Software, Inc.

(21) Appl. No.: 11/006,410

(22) Filed: Dec. 6, 2004

(51) Int. Cl. G06F 12/16

(52) U.S. Cl. 711/162

(57) ABSTRACT

A method for providing logically-consistent computer file backups in an operating environment whose file backup provisions rely on application programs recognizing a freeze writes command but where the operating system also hosts programs that do not recognize such a command. The method intercepts a system level command issued during the backup process that signals the file system manager to flush write operations cached in memory and hold any subsequent write operations. (“Flush and Hold Writes”). File write operations are then monitored to find a quiescent period, which signals that all current file transactions are complete. Application level write operations are halted, preventing any further file transactions. The Flush and Hold Writes Command is then allowed to pass to the file system and volume manager so that these operation system components can flush to permanent storage any write operations that are cached in memory and hold any new write operations.

### TECHNICAL FIELD

The present invention relates to the field of computerized data storage and, more particularly, to methods for making backup copies of open or active computer files. The invention is directed toward computer operating systems which have provisions for making file backups for programs that are compatible with the current operating system, but which do not provide adequate file backups for files that are opened by programs which predate the current operating system.

### BACKGROUND

As the computerized storage of information has blossomed in recent decades, the need for accurate and fast data back-up methods has followed suit. A data backup is a copy of data that is stored on a primary storage media device, with the copy being stored on a separate device in order to protect against the loss of information in the event of a failure of the primary device.

One method of data backup is to perform the task of copying data while a computer system is otherwise idle, such as after the close of business when all files are closed and there is no danger that a file will be backed up while data is being written to it. Increasingly, however, computer systems are in constant use or file backup is required on a more frequent basis than once per day. In these cases, the requirement that no files be open during the backup process is impractical and burdensome for the users of a computer system.

Methods exist for creating file backups while files are open, with programs taking and storing what is often referred to as a “snapshot” of file contents at a specific point in time. The primary problem in any open file backup method is ensuring logical consistency. A file backup is logically consistent when the stored data reflects only completed data transactions and no data backup took place in the middle of a transaction. A simple example of the problem of maintaining logical consistency is an accounting program that stores both income and expenses on a cash basis. If a file backup occurred during storage of a data set including both income and expenses, such that the backup is made after the program had stored income but before it had stored expenses, the backup would reflect an incorrect balance, event though a moment later when the expenses were stored, the actual file would have the correct balance. Such a backup is termed logically inconsistent, and is effectively worthless or worse than no backup at all since it does not record a data set that the user ever intended to be meaningful and there is no indication that the data is not what was intended. A data set taken before the transaction might not be the most current but it would reflect accurate data at the point in time at which it was taken.

One way to ensure that file backups are logically consistent is to halt all write operations at the point that each individual transaction is complete and then take a snapshot of the data to be backed up. This requires that all programs that write to a medium to be backed up be responsive to a system level command to halt all write operations once all logically-consistent transactions are complete.

One software operating system intended to provide logically-consistent open file backups is the Microsoft Windows™ Server 2003, which includes a function called the Volume Shadow Copy Service (“VSS”). VSS uses backup application programs and storage snapshot technology to enable data backups. A key limitation of VSS, however, is that the business application programs, which run on Windows™ Server 2003, must all be compatible with VSS in that they recognize and accept commands to halt further data transactions when a snapshot has been requested. (These are called “Freeze” commands). By halting further data transactions prior to making a snapshot, VSS ensures that only complete, logically consistent, data transactions are recorded in a snapshot and hence a backup. Windows™ Server 2003 also runs programs that predate VSS—so called “legacy programs.” While the details of how VSS treats legacy programs are discussed below, the essential point is that because these programs do not accept the Freeze command from VSS to halt further data transactions, backups of data stored by legacy programs cannot be guaranteed to be logically consistent. There is no way to suspend any further transactions and no way to command a legacy program to finish writing any data transaction that was in process when a data backup was requested. Because of this limitation, a file backup that occurs in the middle of a legacy program transaction has the potential to be logically inconsistent.

Thus, there is a need for a data backup method for programs that do not recognize Freeze commands. The method must also work within an operating system whose open file management system is based on business application programs that do suspend all new data transactions once all active incomplete transactions have concluded, i.e. programs that recognize Freeze commands.

### SUMMARY OF THE INVENTION

The invention addresses the problem of providing logically consistent open file backups in an operating environment, such as Microsoft™ Windows Server 2003, where the operating system relies on application programs recognizing a Freeze command to complete all current data transactions and suspend any new transactions but where the operating system also hosts programs that do not recognize such a command and therefore the data created by these “legacy” programs is not guaranteed to backed up with logical consistency.

The invention relies on intercepting a system level command that signals the operating system's File System and Volume Manager to flush write operations that are cached in memory and hold all new write operations until a snapshot is created. (“Flush and Hold Writes”). The Volume Manager is a low level software driver which manages physical storage media volumes, such as disks. The File System is a higher level driver that, in conjunction with the Volume Manager, enables applications to store and retrieve files on storage devices. The File System specifies naming conventions for files and the format for specifying the path to a file. Together, these drivers are essential to every application (including legacy applications) that stores or retrieves data from a permanent storage device. The system level Flush and Hold Writes command is issued when a backup is requested after VSS-compliant applications have received and processed a Freeze command. To solve the problem of providing logically-consistent backups for older programs that do not recognize Freeze commands, a novel file system driver is disclosed herein that intercepts the Flush and Hold Writes command and does not allow the Flush and Hold Writes command to reach the File System and Volume manager until all legacy programs have completed any in-process transactions. Because legacy programs do not have provisions to signal when a file transaction is complete, an aspect of the invention is to monitor write operations for a significant time period when no write operations have occurred to a volume or set of volumes. The presence of this quiescent period signals a strong likelihood that all current transactions are complete. At this point all application level write operations are halted, which keeps all legacy programs from making any further file transactions. The Flush and Hold Writes command is then allowed to pass to the File System and Volume Manager so that these Operating System components can flush write operations that are cached in memory to permanent storage. The Flush and Hold Writes command also holds any new write operations by delaying their processing until a snapshot is created.

### BRIEF DESCRIPTION OF THE DRAWINGS

The invention is best understood from the following detailed description when read with the accompanying drawing figures.

FIG. 1 is a block diagram illustrating the problem of open file backup with legacy applications programs.

FIG. 2 is a flow diagram of a prior art file backup method that does not include provisions for legacy programs.

FIG. 3 is a flow diagram of an exemplary embodiment of the inventive method.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

The invention is directed toward computer operating systems that have provisions for making file backups based on application programs that recognize a command to complete any current file write transaction and suspend any new file write transactions (Freeze command). Such systems may also run older programs that do not recognize a Freeze command. This limitation hampers the backup of files used by these older or “legacy” programs.

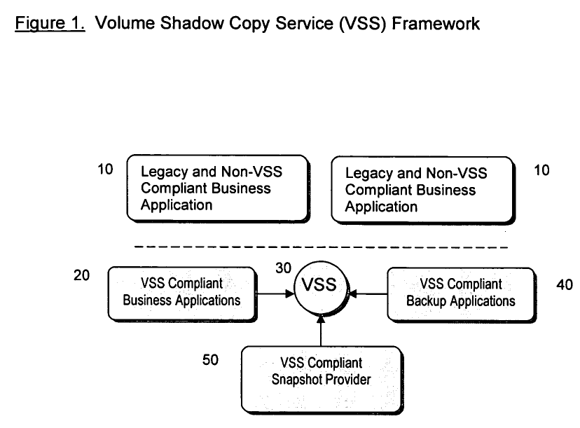

In an exemplary embodiment, the invention is applied in the Microsoft Windows™ Server 2003 computer operating system. This operating system includes a function called the Volume Shadow Copy Service (“VSS”). As depicted in FIG. 1, VSS (30) uses backup applications (“requesters”) (40), business applications (“writers”) (20), and storage snapshot technology (“providers”) (50) to enable data management. The requestors, writers, and providers must be VSS compliant to enable the components to work together to provide a shadow copy, or snapshot, of a set of data volumes. Currently, many applications (10) are not VSS-compliant, including most legacy applications. Many of these legacy applications may never be updated to be compliant because of development and maintenance costs and will forever be excluded from the VSS framework, hence the need for a method of providing logically-consistent file backups for non-compliant programs operating in an environment such as Windows™ Server 2003.

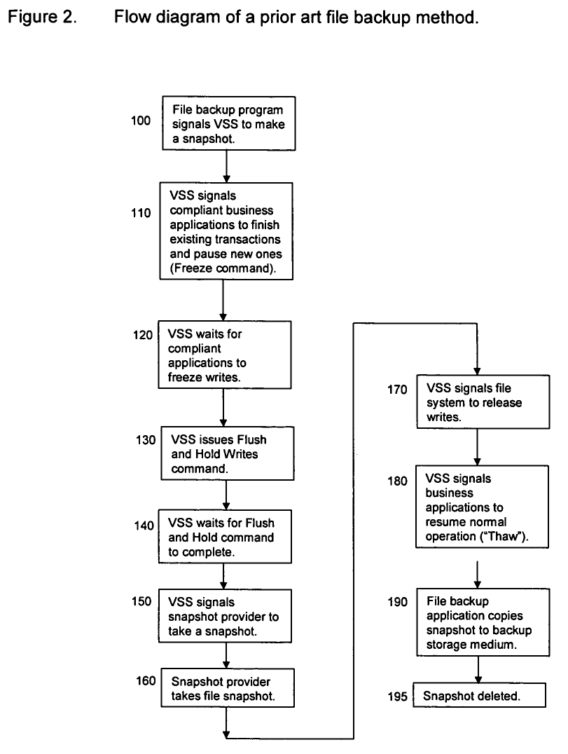

FIG. 2 is a flow diagram of how a file backup is performed in an operating system using VSS. At step 100, a backup application (requestor), sends a command to VSS to take a snapshot. At step 110, VSS communicates with the business applications (writers) to finish existing transactions and pause new transactions. This is called a Freeze command. At step 120 the VSS waits for all VSS-compliant applications to freeze their write operations. After all VSS-compliant applications have frozen write operations, at step 130, VSS issues a Flush and Hold Writes command to the File System and Volume Manager. The operating system is such that when a Flush and Hold Writes command is completed, the command is returned to the VSS to acknowledge that the File System and Volume Manager have received and processed the Flush and Hold Writes command. VSS waits for this acknowledgement at step 140. Upon return of the Flush and Hold Writes acknowledgement, at step 150, VSS signals the snapshot provider to take a snapshot. At step 160, the storage snapshot provider creates a snapshot of the volume set for which the backup is to be made. After the snapshot is taken, at step 170, VSS communicates with the writers to resume normal operations, and at step 180 VSS signals compliant application programs to resume normal operations (a “Thaw” command). At this point the snapshot resides in a temporary disk area used by the snapshot provider, but there is not yet a permanent copy. At step 190, the requestor copies the snapshot creating a backup of the volume set. Since the snapshot is not being accessed by any other application, all files on the volume will appear as closed and available to the requestor even though application programs are accessing the files on the original volume. Upon completion of the backup, at step 195, the requestor communicates with VSS to delete the snapshot.

The problem of ensuring data consistency for programs that are not compatible with VSS (“Legacy writers”) can be solved by using a time-based paradigm to determine when application data is in a consistent state. The premise of the time-based paradigm is that many application programs group together all of the input and output associated with a given transaction and perform that input/output over a very short period of time. This is done to minimize the possibility of application failure, computer system failure, or even power failure from occurring in the middle of executing a transaction. Assuming this type of application design, the time-based paradigm allows the conclusion that no partial transactions are outstanding if a significant period of time has elapsed where no write operations have occurred to a volume or set of related volumes. In the context of mass storage systems, a significant period of time would be on the order of 2 to 5 seconds. Time-based paradigms such as this and their implementation are known to those skilled in the art

In an embodiment of the invention compatible with the Microsoft VSS, a File System Filter Driver (“FSFD”) is introduced into the Windows™ system. This kernel-mode software monitors input/output operations on the system to determine when the VSS framework signals the File System and Volume Manager to Flush and Hold Writes. At that point, the FSFD holds the Flush and Hold Writes command (i.e. temporarily prevents its operation) and monitors write operations to determine a point in time where there has been a significant elapsed time since the last write operation. This period of time is called the Write Inactivity Period (WIP). When a WIP is observed, the FSFD concludes that the legacy application data is consistent and the FSFS then allows the Flush and Hold Writes command to go to the File System for completion. Once this occurs, the snapshot process proceeds as usual, as described in FIG. 2, steps 150 to 195.

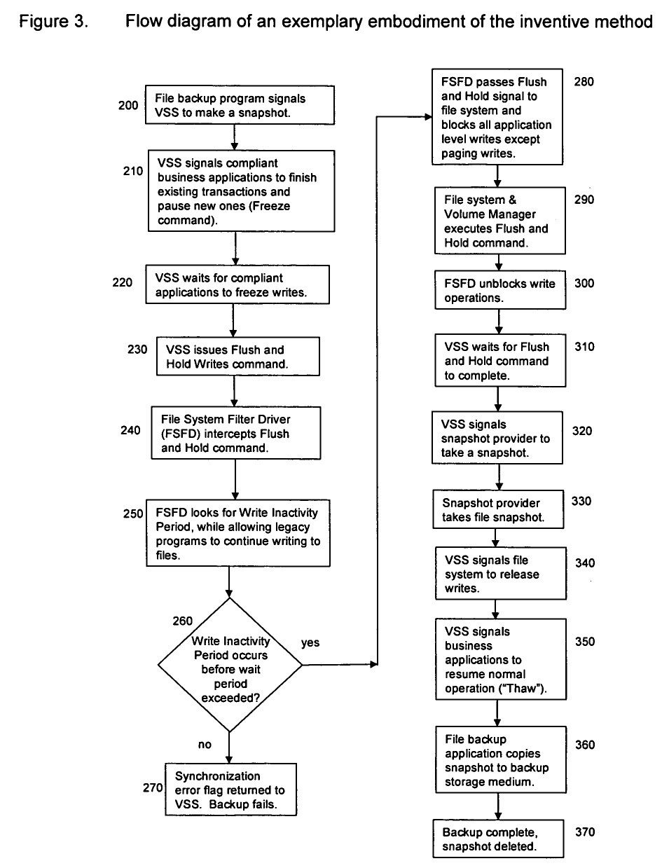

The operation of an exemplary embodiment of the invention compatible with VSS and the Windows™ 2003 Server operating system is shown in FIG. 3. At step 200, a backup application (requester), sends a command to VSS to make a snapshot. At step 210, VSS communicates with the business applications (writers) to finish existing transactions and pause new transactions, by issuing a Freeze command. Non-VSS compliant legacy programs will be unaffected by this step as they do not recognize the Freeze command. At step 220, VSS waits for all compliant programs to acknowledge they have frozen further new write operations. After all VSS-compliant applications have frozen their write operations, at 230, VSS issues a Flush and Hold Writes command. At step 240, the File System Filter Driver (“FSFD”) intercepts the Flush and Hold Writes command and does not initially allow VSS to proceed with the snapshot creation. Instead, at step 250, the FSFD monitors write operations and waits for a Write Inactivity Period (“WIP”). A typical period might be 2 to 5 seconds. At decision point 260, it is determined whether a time-out period has been exceeded before the WIP has occurred. A typical time-out period is 30 seconds. If no WIP is detected within the time-out period, a synchronization error flag, which is well known to those skilled in the art, is returned at step 270, signaling an input/output failure.

If a WIP is detected at decision point 260, at step 280, the FSFD allows the Flush and Hold Writes command to pass to the file system, as would have occurred automatically were it not for the operation of the FSFD. Additionally, the FSFD blocks all application level writes, except paging writes. Paging writes are used by Windows™ Memory manager to support virtual memory. They can be ignored here because they are not relevant to file input/output. Writes are blocked at this point to keep legacy programs from writing to files before the completion of the Flush and Hold Writes command. When the Flush and Hold Writes command is completed by the file system (step 290), the command is returned to the FSFD. At this point (step 300), the FSFD unblocks application level writes and returns the Flush and Hold Writes command to the VSS. At step 310, the VSS waits for the Flush and Hold Writes command to complete. Once the Flush and Hold Writes command is issued to the VSS, the file system will prevent any writes while the Flush and Hold signal is active. Because the FSFD has determined that all legacy transactions are completed prior to releasing the Flush and Hold Writes command to VSS, no legacy write operations will be stopped in the middle of a transaction. Thus, the FSFD ensures that the files of non-VSS-compliant programs are not backed up in the middle of a transaction, as could be the case normally, without the FSFD described herein. The FSFD does not affect the backup data integrity of VSS-compliant applications, because their write operations had already been halted with the issuance at step 210 of the Freeze command.

Once VSS receives the Flush and Hold Writes acknowledgement at step 310, VSS signals the storage snapshot provider to create a snapshot of the volume set for which the backup is to be made, at step 320. At this point operation is the same as it was without the FSFD. The snapshot provider makes the snapshot at step 330. After the snapshot is taken, at step 340, VSS signals the file system to release writes that were held up by the Flush and Hold Writes command. At step 350, VSS signals VSS-compliant applications to thaw, i.e., to release the Freeze that was initiated at step 210. This is termed a Thaw command. At this point the snapshot resides in a temporary disk area used by the snapshot provider, but there is not yet a permanent copy. At step 360, the requestor copies the snapshot creating a backup of the volume set. Since the snapshot is not being accessed by any other application, all files on the volume will appear as closed and available to the requester even though application programs are accessing the files on the original volume. Upon completion of the backup, at step 370, the requester communicates with VSS to delete the snapshot.

The above description is only one embodiment of the invention, as applied in a Microsoft Windows™ 2003 Server operating system with Microsoft's Volume Shadow Copy Service. The foregoing discussion of the invention has been presented for purposes of illustration and description. Further, the description is not intended to limit the invention to the form disclosed herein. Consequently, variations and modifications commensurate with the above teachings and with the skill and knowledge of the relevant art are within the scope of the present invention. The embodiment described herein above is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

In accordance with another aspect, the subject invention comprises a program storage medium that constrains operation of the associated processors. Exemplary computer readable storage devices include conventional computer system RAM (random access memory), ROM (read only memory), EPROM (erasable, programmable ROM), EEPROM (electrically erasable, programmable ROM), flash memory, and magnetic or optical disks or tapes. Exemplary computer readable signals, whether modulated using a carrier or not, are signals that a processor hosting or running the program may be configured to access, including signals downloaded through the Internet or other networks. Examples of the foregoing include distribution of the program(s) on a CD ROM or via Internet download.

In the form of processes and apparatus implemented by digital processors, the associated programming medium and computer program code is loaded into and executed by a processor, or may be referenced by a processor that is otherwise programmed, so as to constrain operations of the processor and/or other peripheral elements that cooperate with the processor. Due to such programming, the processor or computer becomes an apparatus that practices the method of the invention as well as an embodiment thereof. When implemented on a general-purpose processor, the computer program code segments configure the processor to create specific logic circuits. Such variations in the nature of the program carrying medium, and in the different configurations by which computational and control and switching elements can be coupled operationally, are all within the scope of the present invention.

What is claimed is:

1. A method of creating back-up data files in a computer operating system comprising:
observing operating system commands to detect issuance of a command to flush and hold write operations;
intercepting said command to flush and hold write operations;
observing data storage write operations to detect a period of inactivity of said data storage write operations;
determining that said period of inactivity indicates that all stored data to be backed up is logically consistent; and
releasing said flush and hold write operations command to said operating system.

2. The method of claim 1, wherein said releasing follows said determining and further comprising:
blocking application write operations after said determining and before said releasing; and
unblocking said application write operations after said releasing.

3. The method of claim 2, further comprising:
creating a temporary snapshot of said stored data if said period of inactivity occurs within a set time limit; and
permanently storing said snapshot.

4. The method of claim 3 further comprising providing a snapshot provider application program that creates said temporary snapshot.

5. The method of claim 2 further comprising setting a minimum threshold for said period of inactivity to be detected, said minimum threshold having a value within a range of 2 to 5 seconds.

6. The method of claim 3 wherein, after said releasing, said operating system waits for said flush and hold write operations to complete before said creating a temporary snapshot.

7. The method of claim 3 further comprising determining whether said period of inactivity occurs within said set time limit, and, if said period of inactivity does not occur within said set time limit, no snapshot is created.

8. The method of claim 7 wherein said set time limit is within a range of 25 to 35 seconds.

9. A method of creating back-up data files in a computer operating system comprising:
initiating a data backup process;
signaling application programs that accept a freeze writes command to complete all current data storage write operations and halt all future data storage write operations;
issuing a flush and hold write operations command;
intercepting said flush and hold write operations command;
observing data storage write operations to detect a period of inactivity of said data storage write operations;
determining that said period of inactivity indicates that all stored data to be backed up is logically consistent;
blocking application write operations;
releasing said flush and hold write operations command to said operating system;
unblocking said application write operations after execution of said flush and hold write operations command; and,
signaling application programs that accept said freeze writes command to resume normal data storage write operations.

10. The method of claim 9 further comprising setting a minimum threshold for said period of inactivity to be detected, said minimum threshold having a value within a range of 2 to 5 seconds.

11. The method of claim 9, further comprising:
creating a temporary snapshot of said stored data if said period of inactivity occurs within a set time limit; and,
permanently storing said snapshot.

12. The method of claim 11 further comprising providing a snapshot provider application program that creates said temporary snapshot.

13. The method of claim 11 wherein, after said releasing, said operating system waits for said flush and hold write operations to complete before said creating a temporary snapshot.

14. The method of claim 11 further comprising determining whether said period of inactivity occurs within said set time limit, and if said period of inactivity does not occur within said set time limit, no snapshot is created.

15. The method of claim 14 wherein said set time limit is within a range of 25 to 35 seconds.

16. A computer program product with encoded instructions for performing operations comprising:
observing operating system commands to detect issuance of a command to flush and hold write operations;
intercepting said command to flush and hold write operations;
observing data storage write operations to detect a period of inactivity of said data storage write operations;
determining that said period of inactivity indicates that all stored data to be backed up is logically consistent; and
releasing said flush and hold write command to said operating system.

17. The computer program product of claim 16, further comprising encoded instructions for:
blocking application write operations after said determining and before said releasing; and
unblocking said application write operations after said releasing.

18. The computer program product of claim 17, further comprising encoded instructions for performing operations:
creating a temporary snapshot of said stored data if said period of inactivity occurs within a set time limit; and
permanently storing said snapshot.

19. The computer program product of claim 17 wherein said encoded instructions include a minimum threshold for said period of inactivity to be detected, said minimum threshold having a value within a range of 2 to 5 seconds.

20. The computer program product of claim 18, further comprising encoded instructions for waiting for said flush and hold write operations to complete before creating said temporary snapshot.

21. The computer program product of claim 18, further comprising encoded instructions for determining whether said period of inactivity occurs within said time limit, and if said period of inactivity does not occur within said time limit, for no snapshot being created.

22. The computer program product of claim 21 wherein said set time limit is within a range of 25 to 35 seconds.

23. The computer program product of claim 17, further comprising encoded instructions for performing operations:
signaling applications programs that accept a freeze writes command to complete all current write operations and halt all future write operations prior to said observing operating system commands to detect issuance of a command to flush and hold write operations;
signaling said application programs that accept a freeze writes command to resume normal operations after said releasing said flush and hold write operations command.
